(19) United States
(12) Patent Application Publication
(10) Pub. No.: US 2014/0295363 A1
(43) Pub. Date: Oct. 2, 2014

(54) PLASTIC FLAME HOUSING AND METHOD OF MAKING THE SAME

(71) Applicants: Xiaoyu Sun, Evansville, IN (US); Yaming Niu, Shanghai (CN); Richard Faris, Ontario (CA); Srinivas Siripurapu, Carmel, IN (US)

(72) Inventors: Xiaoyu Sun, Evansville, IN (US); Yaming Niu, Shanghai (CN); Richard Faris, Ontario (CA); Srinivas Siripurapu, Carmel, IN (US)

(73) Assignee: SABIC Innovative Plastics IP B.V., Bergen op Zoom (NL)

(21) Appl. No.: 14/350,528

(22) PCT Filed: Oct. 8, 2011
(86) PCT No.: PCT/CN2011/080549

§ 371 Date: Apr. 30, 2014

(51) Int. Cl. F21V 35/00

(52) U.S. Cl. CPC F21V 35/00
USPC 431/291

(57) ABSTRACT

A flame element can comprise: a flame housing, fuel, and a medium for a flame. The flame housing is formed from a composition comprising: (a) a first polycarbonate having a LOI of greater than or equal to 25% and a glass transition temperature of greater than 170° C. as measured using a differential scanning calorimetry method, wherein the first polycarbonate is derived from a monomer having the structure wherein each of A₁ and A₂ comprise a monocyclic divalent arylene group, and Y₁ is a bridging group having one or more atoms, and wherein the structure is free of halogen atoms; 10 and (b) a second polycarbonate different than the first polycarbonate.

### TECHNICAL FIELD

Disclosed herein are plastic flame housings, especially plastic candle housings and methods of making the same.

### BACKGROUND

Candles have an open flame burning from a wick and a combustible material (wax, oil, and so forth). The container candles, such as tea lights, generally have a glass, metal, or ceramic housing. For reasons of aesthetics, transparent materials for the housings are desired. However, due to the increasing costs of glass and the brittleness thereof, alternative transparent housings capable of withstanding the temperature conditions and fire issues associated with an open flame, are continually sought.

### SUMMARY

Disclosed herein are plastic flame housings and methods of making and using the same.

In one embodiment, a flame element can comprise: a flame housing, a fuel located in the flame housing; and a medium for a flame located in the housing and in contact with the fuel. The flame housing is formed from a polycarbonate blend comprising: a first polycarbonate having a glass transition temperature (Tg) of greater than 170° C. as measured using a differential scanning calorimetry method, wherein the first polycarbonate is derived from a monomer having the structure HO-A₁-Y₁-A₂-OH wherein each of A₁ and A₂ comprise a monocyclic divalent arylene group, and Y₁ is a bridging group having an atom, and wherein the structure is free of halogen atoms; and a second polycarbonate different than the first polycarbonate. The polycarbonate blend can have one or more of the following characteristics: a Tg of greater than or equal to 170° C. as measured using a differential scanning calorimetry method, a 3.2 mm molded plaque from the blend has a YI of less than or equal to 10, a 3.2 mm molded plaque from the polycarbonate blend having a transmission of greater than 80% as measured using a method of ASTM D 1003-07, and a molded plaque of the polycarbonate blend possesses a greater than or equal to a UL94 V0 rating at 3.0 mm thickness, and specifically, at 2.5 mm thickness.

In another embodiment, a flame element can comprise: a flame housing; a fuel located in the flame housing; and a medium for a flame located in the housing and in contact with the fuel. The flame housing is formed from a polycarbonate blend comprising: (i) a first polycarbonate having a Tg of greater than 170° C. as measured using a differential scanning calorimetry method, wherein the first polycarbonate comprises carbonate units derived from at least one of the following monomers: 3,3-bis(4-hydroxyphenyl)-2-phenylisoindolin-1-one (PPPBP), 1,1-bis(4-hydroxyphenyl)-1-phenyl-ethane (Bisphenol-AP), and 1,1-bis(4-hydroxyphenyl)-3,3,5-trimethyl-cyclohexane (Bisphenol-TMC); and (ii) a second polycarbonate different than the first polycarbonate. A molded article of the polycarbonate blend has a transmission of greater than or equal to 70% as measured using the method of ASTM D 1003-07 at 3.2 mm in part thickness. The polycarbonate blend possesses greater than or equal to a UL94 V0 rating at 3.0 mm thickness.

In yet another embodiment, a flame element can comprise: a flame housing, a fuel located in the flame housing, and a medium for a flame located in the housing and in contact with the fuel. The flame housing is formed from a polymer blend comprising: a thermoplastic polymer, and a 2-phenyl-3,3-bis(4-hydroxyphenyl)phthalimidine/BPA polycarbonate copolymer in an amount greater than 7 wt % of a total weight of the blend. The polymer blend is free of a flame retardant phosphorous containing compound, and has at least a UL94 V0 fire rating at a thickness of 3.0 mm. The thermoplastic polymer and the 2-phenyl-3,3-bis(4-hydroxyphenyl)phthalimidine/BPA polycarbonate copolymer are different, and wherein the 2-phenyl-3,3-bis(4-hydroxyphenyl)phthalimidine/BPA polycarbonate copolymer has a yellowness index (YI) of less than 10 as measured on a 3 mm thick plaque in accordance with ASTM D1925.

These and other non-limiting characteristics are more particularly described below.

### BRIEF DESCRIPTION OF THE DRAWING

The following is a brief description of the drawing, which are presented for the purposes of illustrating the exemplary embodiments disclosed herein and not for the purposes of limiting the same.

FIG. 1 is an embodiment of a tea light cup formed from a high heat plastic located in a metal container for testing purpose.

### DETAILED DESCRIPTION

Disclosed herein is a candle housing formed from a plastic/polycarbonate containing material having a glass transition temperature (Tg) of greater than or equal to 170° C., wherein, when molded, a 3.2 mm molded article from the blend formulation has a yellowness index (YI) of less than 10, a transmission of greater than or equal to 75% (specifically greater than or equal to 80%), and a UL94 V0 rating at a 3.0 mm thickness, specifically at 2.5 mm thickness; and wherein the blend comprised a first plastic/polycarbonate containing material has a limited oxygen index (LOI) of greater than or equal to 25%.

As is readily understood, a candle housing can attain temperatures of greater than or equal to 160° C. As a result, plastic housings, without a specific design, were not possible because of melt issues. Even if the plastic did not melt, it would deform. It has been discovered that plastics having a Tg of greater than or equal to 170° C., and wherein, when molded to a 3.2 mm plaque, the plaque has a YI of less than 10, and a transmission of greater than 80%, and, at a 3.0 mm thick plaque, has a UL94 V0 rating, can be used as a flame housing without melting or warping during use, e.g., exposure to an open flame.

Plastics useful for the housing, therefore, include a first plastic having a LOI of greater than or equal to 25%, specifically, greater than or equal to 30%, more specifically, greater than or equal to 33%, and yet more specifically, greater than or equal to 40%. The Tg can be greater than or equal to 170° C., specifically, greater than or equal to 180° C., and more specifically, greater than or equal to 185° C. When molded, a suitable plastic has a YI of less than 10, specifically, less than or equal to 5, and more specifically, less than or equal to 2, at a thickness of 3.2 mm as determined in accordance with ASTM D1925. The molded plastic also has a transmission of greater than or equal to 80%, specifically, greater than or equal to 82%, more specifically, greater than or equal to 83%, and yet more specifically, greater than or equal to 85%, at a thickness of 3.2 mm, and has a UL94 V0 rating at a 3.0 mm thickness, specifically, at 2.5 mm, and more specifically, 2.0 mm. In addition to these properties, desirably, the plastic also should be moldable (e.g., injection moldable) into thin wall parts, e.g. 1 mm thick. Desirably, the melt flow rate (MFR) of the blended formulation can be 15 grams per cubic centimeter (g/cm³) to 60 g/cm³, specifically, 15 g/cm³ to 30 g/cm³, more specifically, 20 g/cm³ and 30 g/cm³ as measured at 330° C., 2.16 kg according to ASTM D 1238 and/or a MFR suitable to mold/extrude a thin wall part with the characteristic features articulated in this disclosure.

In one embodiment, the plastic is a polymer blend comprising at least one thermoplastic polymer and a polymer comprising structural units derived from a 2-hydrocarbyl-3,3-bis(4-hydroxyaryl)phthalimidine.

In yet another embodiment, the plastic is a polymer blend comprising at least one thermoplastic polymer, and a 2-phenyl-3,3-bis(4-hydroxyphenyl)phthalimidine/BPA copolymer in an amount greater than 7 weight percent of the total weight of the blend, wherein the polymer blend is free of a flame retardant phosphorous containing compound, and has at least a V0 fire rating as measured in accordance with Underwriter Laboratories UL94 Vertical Burn Test procedure dated, Jul. 29, 1997.

In still another embodiment, the plastic can be a polymer blend comprising at least one thermoplastic polymer and a polymer comprising structural units derived from a 2-hydrocarbyl-3,3-bis(4-hydroxyaryl)phthalimidine, where the blend does not comprise a phosphorous based or brominated flame retardants.

### 1. DEFINITIONS

The terminology used herein is for the purpose of describing particular embodiments only and is not intended to be limiting. As used in the specification and the appended claims, the singular forms “a,” “and” and “the” include plural references unless the context clearly dictates otherwise. The terms “first,” “second,” and the like, “primary,” “secondary,” and the like, as used herein do not denote any order, quantity, or importance, but rather are used to distinguish one element from another. The endpoints of all ranges directed to the same component or property are inclusive of the endpoints, are independently combinable, and include all intermediate points and ranges. The suffix “(s)” as used herein is intended to include both the singular and the plural of the term that it modifies, thereby including one or more of that term (e.g., the additive(s) includes one or more additives).

In general, the blend and the flame element can alternately comprise, consist of, or consist essentially of, any appropriate components herein disclosed. They can additionally, or alternatively, be formulated so as to be devoid, or substantially free, of any components, materials, ingredients, adjuvants or species used in the prior art compositions or that are otherwise not necessary to the achievement of the function and/or objectives hereof.

Reference throughout the specification to “one embodiment”, “another embodiment”, “an embodiment”, and so forth, means that a particular element (e.g., feature, structure, and/or characteristic) described in connection with the embodiment is included in at least one embodiment described herein, and can or can not be present in other embodiments. In addition, it is to be understood that the described elements can be combined in any suitable manner in the various embodiments.

“Alkyl” as used herein includes a linear, branched, or cyclic group, such as a methyl group, ethyl group, n-propyl group, isopropyl group, n-butyl group, isobutyl group, tert-butyl group, n-pentyl group, isopentyl group, n-hexyl group, isohexyl group, cyclopentyl group, cyclohexyl group, and the like.

As used herein, “combination” is inclusive of blends, mixtures, alloys, reaction products, and the like.

“Copolymer” as used herein includes a polymer derived from two or more structural unit or monomeric species, as opposed to a homopolymer, which is derived from only one structural unit or monomer.

“C₃-C₆ cycloalkyl” as used herein includes cyclopropyl, cyclobutyl, cyclopentyl and cyclohexyl.

The flammability rating (e.g., V0) is determined according to Underwriter Laboratories UL-94 Vertical Burn Test procedure dated Jul. 29, 1997.

“Glass Transition Temperature” or “Tg” as used herein is a measure of heat resistance of the corresponding polycarbonate and polycarbonate blends. The Tg can be determined by differential scanning calorimetry. The calorimetry method can use a TA Instruments Q1000 instrument, for example, with setting of 20° C./min ramp rate and 40° C. start temperature and 200° C. end temperature.

“Halo” as used herein includes a substituent to which the prefix is attached is substituted with one or more independently selected halogen radicals. For example, “C₁-C₆ haloalkyl” means a C₁-C₆ alkyl substituent wherein one or more hydrogen atoms are replaced with independently selected halogen radicals. Non-limiting examples of C₁-C₆ haloalkyl include chloromethyl, 1-bromoethyl, fluoromethyl, difluoromethyl, trifluoromethyl, and 1,1,1-trifluoroethyl. It should be recognized that if a substituent is substituted by more than one halogen radical, those halogen radicals can be identical or different (unless otherwise stated).

“Halogen” or “halogen atom” as used herein includes a fluorine, chlorine, bromine, or iodine atom.

“Haze” as used herein refers to that percentage of transmitted light, which in passing through a specimen deviates from the incident beam by forward scattering. Percent (%) haze can be measured according to ASTM D1003-07, Procedure A, measured, e.g., using a HAZE-GUARD DUAL from BYK-Gardner, using and integrating sphere (0°/diffuse geometry), wherein the spectral sensitivity conforms to the International Commission on Illumination (CIE) standard spectral value under standard lamp D65.

“Heteroaryl” as used herein includes any aromatic heterocyclic ring which can comprise an optionally benzocondensed 5 or 6 membered heterocycle with from 1 to 3 heteroatoms selected among N, O or S. Non limiting examples of heteroaryl groups can include pyridyl, pyrazinyl, pyrimidinyl, pyridazinyl, indolyl, imidazolyl, thiazolyl, isothiazolyl, pyrrolyl, phenyl-pyrrolyl, furyl, phenyl-furyl, oxazolyl, isoxazotyl, pyrazolyl, thienyl, benzothienyl, isoindolinyl, benzoimidazolyl, quinolinyl, isoquinolinyl, 1,2,3-triazolyl, 1-phenyl-1,2,3-triazolyl, and the like.

“Hindered phenol stabilizer” as used herein includes 3,5-di-tert-butyl-4-hydroxyhydrocinnamic acid, octadecyl ester.

“Limited Oxygen Index” (LOT) is determined in accordance with ISO 4589-2.

“Melt Flow Rate” (MFR) as used herein refers to the flow rate of a polymer in a melt phase in units of grams per 10 minutes (g/10 min) were determined according to ASTM D1238 under conditions of 330° C. and an applied mass of 2.16 kilograms (kg).

“Percent transmission” or “% transmission” as used herein refers to the ratio of transmitted light to incident light and can be measured according to ASTM D1003-07, Procedure A, measured, e.g., using a HAZE-GUARD DUAL from BYK-Gardner, using and integrating sphere (0°/diffuse geometry), wherein the spectral sensitivity conforms to the International Commission on Illumination (CIE) standard spectral value under standard lamp D65.

“PETS” as used herein includes pentaerythritol tetrastearate.

“Phosphite stabilizer” as used herein includes tris-(2,4-di-tert-butylphenyl) phosphite.

“Polycarbonate” as used herein includes an oligomer or polymer comprising residues of one or more polymer structural units, or monomers, joined by carbonate linkages. The polycarbonate can be linear and/or branched.

“Straight or branched C₁-C₃ alkyl” or “straight or branched C₁-C₃ alkoxy” as used herein includes methyl, ethyl, n-propyl, isopropyl, methoxy, ethoxy, n-propoxy and isopropoxy.

Unless otherwise indicated, each of the foregoing groups can be unsubstituted or substituted, provided that the substitution does not significantly adversely affect synthesis, stability, or use of the compound.

The terms “structural unit” and “monomer” are interchangeable as used herein.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

For the purposes of this disclosure, the term “hydrocarbyl” is defined herein as a monovalent moiety formed by removing a hydrogen atom from a hydrocarbon. Representative hydrocarbyls are alkyl groups having 1 to 25 carbon atoms, such as methyl, ethyl, propyl, butyl, pentyl, hexyl, heptyl, octyl, nonyl, undecyl, decyl, dodecyl, octadecyl, nonadecyl, eicosyl, heneicosyl, docosyl, tricosyl, and the isomeric forms thereof; aryl groups having 6 to 25 carbon atoms, such as ring-substituted and ring-unsubstituted forms of phenyl, tolyl, xylyl, naphthyl, biphenyl, tetraphenyl, and the like; aralkyl groups having 7 to 25 carbon atoms, such as ring-substituted and ring-unsubstituted forms of benzyl, phenethyl, phenpropyl, phenbutyl, naphthoctyl, and the like; and cycloalkyl groups, such as cyclopropyl, cyclobutyl, cyclopentyl, cyclohexyl, cycloheptyl, cyclooctyl, and the like. The term “aryl′ as used herein refers to various forms of aryl groups that have been described hereinabove for the “hydrocarbyl” group.

### 2. POLYCARBONATE BLEND

The herein described polycarbonate blend comprises one or more first polycarbonates and one or more second polycarbonates. The polycarbonate blend can have: (i) a molded part from the polycarbonate blend can have a UL flame rating of V0 at a thickness of 3.0 mm (specifically, 2.5 mm); (ii) a Tg of greater than or equal to 170° C., more specifically greater than or equal to 175° C., and yet more specifically greater than or equal to 185° C.; (iii) a molded part of the blend has a YI of less than or equal to 10, specifically less than or equal to 7, and yet more specifically less than or equal to 5 at a thickness of 3.2 mm; and/or (iv) a transmission of greater than or equal to 75%, specifically, greater than or equal to 80%, and yet more specifically, greater than or equal to 85% at a thickness of 3.2 mm; (v) or a combination comprising at least one of the foregoing.

The polycarbonate blend can comprise greater than 50 wt %, 60 wt %, 65 wt %, 70 wt %, 75 wt %, 80 wt %, 85 wt %, 90 wt %, or 95 wt % of the first polycarbonate. The polycarbonate can comprise between 80 wt % and 90 wt % of the first polycarbonate. The polycarbonate blend can comprise less than 50 wt %, 40 wt %, 35 wt %, 30 wt %, 25 wt %, 20 wt %, 15 wt %, 10 wt %, or 5 wt % of the second polycarbonate. The polycarbonate blend can comprise between 10 wt % and 20 wt % of the second polycarbonate. The sum of the weight (wt) percentages for the first and second polycarbonates can equal 100 wt %. The first and/or second polycarbonate can be branched.

The polycarbonate blend can have a percent (%) haze of less than 5%, 4.5%, 4.0%, 3.5%, 3.0%, 2.5%, 2.0% or 1.0%. The polycarbonate blend can have a transmission of greater than or equal to 80%, 85%, 90%, or 95% on parts 3.0 mm, specifically 2.0 mm, and more specifically 1 mm in thickness. The polycarbonate blend can have a percent haze of less than of 3.5% and a percent transmission of greater than or equal to 80% as measured using a method of ASTM D1003-07 on parts 3.0 mm in thickness.

The herein described polycarbonate blends can have an MFR of 10 to 65 grams, specifically, 15 to 45 grams, and more specifically 20 to 30 grams, per 10 minutes (g/10 min) determined according to ASTM D1238 under conditions of 330° C. and an applied mass of 2.16 kilograms (kg). Mixtures of polycarbonates of different flow properties can be used to achieve the overall desired flow property.

The polycarbonate blend for use as a flame housing exhibits a heat resistance that is greater than that of bisphenol A polycarbonate homopolymer alone.

a. First Polycarbonate

Described herein is the first polycarbonate of the polycarbonate blend. The first polycarbonate can be a homopolycarbonate or a copolycarbonate derived from one dihydroxy aromatic monomer or a combination of two or more dihydroxy aromatic monomers, respectively, such that the homopolycarbonate or the copolycarbonate has a glass transition temperature (Tg) of greater than or equal to 170° C. The dihydroxy aromatic monomer of the homopolycarbonate must produce a polycarbonate with a Tg of greater than or equal to 170° C. If more than one dihydroxy aromatic monomer is present in the copolycarbonate, the combination of dihydroxy aromatic monomers should produce a polycarbonate with a Tg of greater than or equal to 170° C.

The first polycarbonate can alternatively be a polyester polycarbonate copolymer having a Tg of greater than or equal to 170° C. The polyester polycarbonate can be a combination of a polyester structural unit and a polycarbonate structural unit. The polyester structural unit can be derived from a C₆-C₂₀ aromatic dicarboxylic acid or C₆-C₂₀ aromatic dicarboxylic acid chlorides and one or more dihydroxy aromatic monomers. The polycarbonate structural unit can be derived from one or more dihydroxy aromatic monomers. The dihydroxy aromatic monomers of the polyester structural unit and the polycarbonate structural unit can be the same or different. Details of these structural units of the first polycarbonate are discussed below.

(i) Homopolycarbonate/Copolycarbonate

The first polycarbonate can be a homopolycarbonate or a copolycarbonate. The term “polycarbonate” and “polycarbonate resin” mean compositions having repeating structural carbonate units of the formula (1):

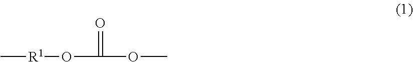

in which greater than or equal to 60% of the total number of R¹ groups are aromatic organic groups and the balance thereof are aliphatic, alicyclic, or aromatic groups. In one embodiment, each R¹ is an aromatic organic group, for example a group of the formula (2):

-A¹-Y¹-A²- (2)

wherein each of A¹ and A² is a monocyclic divalent aryl group and Y¹ is a bridging group having one or two atoms that separate A¹ from A². For example, one atom can separate A¹ from A², with illustrative examples of these groups including —O—, —S—, —S(O)—, —S(O)₂—, —C(O)—, methylene, cyclohexyl-methylene, 2-[2.2.1]-bicycloheptylidene, ethylidene, isopropylidene, neopentylidene, cyclohexylidene, cyclopentadecylidene, cyclododecylidene, and adamantylidene. The bridging group Y¹ can be a hydrocarbon group or a saturated hydrocarbon group such as methylene, cyclohexylidene, or isopropylidene.

The polycarbonates can be produced from dihydroxy compounds having the formula HO—R¹—OH, wherein R¹ is defined as above for formula (1). The formula HO—R¹—OH includes bisphenol compounds of formula (3):

HO-A¹-Y¹-A²-OH (3)

wherein Y¹, A¹ and A² are as described above. Included are bisphenol compounds of general formula (4):

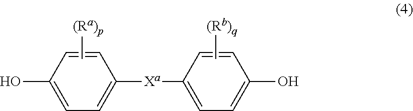

wherein R^{a} and R^{b} each represent a halogen atom or a monovalent hydrocarbon group and can be the same or different; p and q are each independently integers of 0 to 4; and X^{a} represents one of the groups of formula (5):

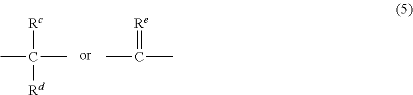

wherein R^{c} and R^{d} each independently represent a hydrogen atom or a monovalent linear alkyl or cyclic alkylene group and R^{e} is a divalent hydrocarbon group. In an embodiment, R^{c} and R^{d} represent a cyclic alkylene group; or a heteroatom-containing cyclic alkylene group comprising carbon atoms and heteroatoms with a valency of two or greater. In an embodiment, a heteroatom-containing cyclic alkylene group comprises at least one heteroatom with a valency of 2 or greater, and at least two carbon atoms. Examples of heteroatoms for use in the heteroatom-containing cyclic alkylene group include —O—, —S—, and —N(Z)—, where Z is a substituent group selected from hydrogen, C₁₋₁₂ alkyl, C₁₋₁₂ alkoxy, or C₁₋₁₂ acyl. Where present, the cyclic alkylene group or heteroatom-containing cyclic alkylene group can have 3 to 20 atoms, and can be a single saturated or unsaturated ring, or fused polycyclic ring system wherein the fused rings are saturated, unsaturated, or aromatic.

Non-limiting examples of dihydroxy compounds that can provide polycarbonates with Tgs greater than 170° C. include 3,3-bis(4-hydroxyphenyl)-2-phenylisoindolin-1-one (PPPBP), 1,1-bis(4-hydroxyphenyl)-3,3,5-trimethylcyclohexane) (Bisphenol TMC), 4,4′-(1-phenylethane-1,1-diyl)diphenol (Bisphenol AP) as well as adamantyl containing aromatic dihydroxy compounds, and fluorene containing aromatic dihydroxy compounds.

A specific example of dihydroxy compounds of formula (3) can be the following formula (6)

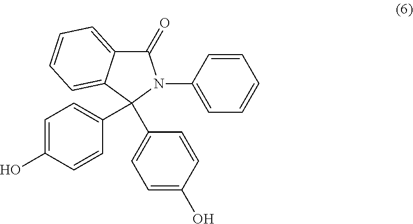 [SMILES: O=C1c2ccccc2C(c2ccc(O)cc2)(c2ccc(O)cc2)N1c1ccccc1]

(also known as 3,3-bis(4-hydroxyphenyl)-2-phenylisoindolin-1-one (PPPBP)) also known as 2-phenyl-3,3-bis(4-hydroxyphenyl)phthalimidine.

Alternatively, the dihydroxy compounds of formula (3) can be the following formula (7):

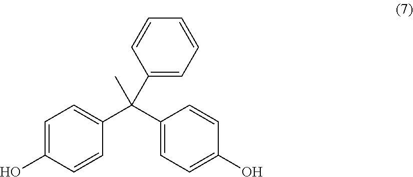 [SMILES: CC(c1ccccc1)(c1ccc(O)cc1)c1ccc(O)cc1]

(also known as 4,4′-(1-phenylethane-1,1-diyl)diphenol (bisphenol AP) also known as 1,1-bis(4-hydroxyphenyl)-1-phenyl-ethane).

Alternatively, the dihydroxy compounds of formula (3) can be the following formula (8):

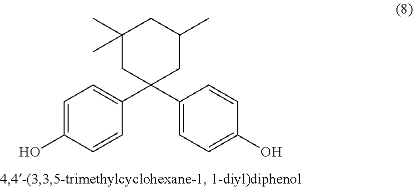 [SMILES: CC1CC(C)(C)CC(c2ccc(O)cc2)(c2ccc(O)cc2)C1]

(bisphenol TMC) also known as 1,1-bis(4-hydroxyphenyl)-3,3,5-trimethylcyclohexane).

Other bisphenols containing substituted or unsubstituted cyclohexane units can be used, for example, bisphenols of formula (9):

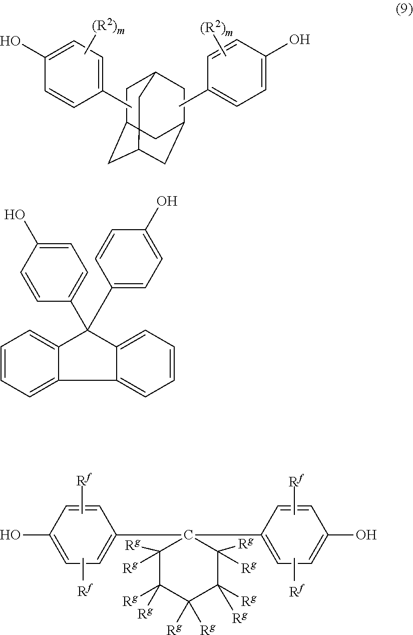

wherein each R² or R^{f} is independently C₁₋₁₂ alkyl, or halogen; m is 0 to 4; and each R^{g} is independently hydrogen or C₁₋₁₂ alkyl. The substituents can be aliphatic or aromatic, straight-chain, cyclic, bicyclic, branched, saturated, or unsaturated. Such cyclohexane-containing bisphenols, for example the reaction product of two moles of a phenol with one mole of a hydrogenated isophorone, are useful for making polycarbonate polymers with high glass transition temperatures and high heat distortion temperatures.

Other useful dihydroxy compounds having the formula HO—R¹—OH that can be used in combination with monomers that form polycarbonates with Tgs greater than 170° C. include aromatic dihydroxy compounds of formula (10):

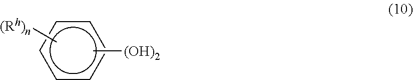

wherein each R^{h} is independently a halogen atom, a C₁₋₁₀ hydrocarbyl such as a C₁₋₁₀ alkyl group, a halogen substituted C₁₋₁₀ hydrocarbyl such as a halogen-substituted C₁₋₁₀ alkyl group, and n is 0 to 4. The halogen is usually bromine.

Some examples of dihydroxy compounds include: 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis(hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-, alpha, alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl) sulfide, bis(4-hydroxyphenyl)sulfoxide, bis(4-hydroxyphenyl)sulfone, 9,9-bis(4-hydroxyphenyl)fluorine, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole, resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, and the like, as well as combinations comprising at least one of the foregoing dihydroxy compounds.

Specific examples of bisphenol compounds that can be represented by formula (3) include 1,1-bis(4-hydroxyphenyl) methane, 1,1-bis(4-hydroxyphenyl) ethane, 2,2-bis(4-hydroxyphenyl) propane (hereinafter “bisphenol A” or “BPA”), 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, 1,1-bis(4-hydroxy-t-butylphenyl) propane, and 1,1-bis(4-hydroxy-3-methylphenyl)cyclohexane (DMBPC). Combinations comprising at least one of the foregoing dihydroxy compounds can also be used.

The dihydroxy compounds of formula (3) can be the following formula (11):

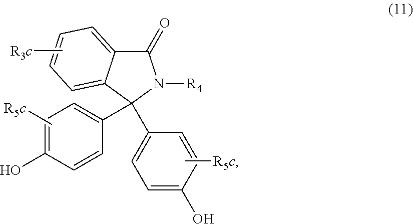

wherein R₃ and R₅ are each independently a halogen or a C₁₋₆ alkyl group, R₄ is a C₁₋₆ alkyl, phenyl, or phenyl substituted with up to five halogens or C₁₋₆ alkyl groups, and c is 0 to 4. In a specific embodiment, R₄ is a C₁₋₆ alkyl or phenyl group. In still another embodiment, R₄ is a methyl or phenyl group. In another specific embodiment, each c is 0.

(ii) Polyester Polycarbonates

The first polycarbonate can be a copolymer comprising different R¹ moieties in the carbonate. The copolymer can comprise other types of polymer or monomer units, such as ester units, and combinations comprising at least one of homopolycarbonates and copolycarbonates as described above in section (1) of the first polycarbonate. A specific type of copolymer can be a polyester carbonate, also known as a polyester-polycarbonate. The copolymers can further contain, in addition to recurring carbonate chain units of the formula (1) as described above, repeating units of formula (12):

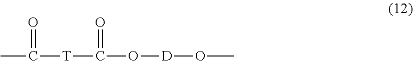

wherein O-D-O is a divalent group derived from a dihydroxy compound, and D can be, for example, one or more alkyl containing C₆-C₂₀ aromatic group(s), or one or more C₆-C₂₀ aromatic group(s), a C₂₋₁₀ alkylene group, a C₆₋₂₀ alicyclic group, a C₆₋₂₀ aromatic group or a polyoxyalkylene group in which the alkylene groups contain 2 to 6 carbon atoms, specifically 2, 3, or 4 carbon atoms; and T is a divalent group derived from a dicarboxylic acid, and can be, for example, a C₂₋₁₀ alkylene group, a C₆₋₂₀ alicyclic group, a C₆₋₂₀ alkyl aromatic group, or a C₆₋₂₀ aromatic group.

In one embodiment, D can be a C₂₋₃₀ alkylene group having a straight chain, branched chain, or cyclic (including polycyclic) structure. In another embodiment, O-D-O can be derived from an aromatic dihydroxy compound of formula (3) above. In another embodiment, O-D-O can be derived from an aromatic dihydroxy compound of formula (4) above. In another embodiment, O-D-O can be derived from an aromatic dihydroxy compound of formula (10) above.

Examples of aromatic dicarboxylic acids that can be used to prepare the polyester units include isophthalic or terephthalic acid, 1,2-di(p-carboxyphenyl)ethane, 4,4′-dicarboxydiphenyl ether, 4,4′-bisbenzoic acid, and combinations comprising at least one of the foregoing acids. Acids containing fused rings can also be present, such as in 1,4-, 1,5-, or 2,6-naphthalenedicarboxylic acids. Specific dicarboxylic acids can be terephthalic acid, isophthalic acid, naphthalene dicarboxylic acid, cyclohexane dicarboxylic acid, or combinations thereof. A specific dicarboxylic acid comprises a combination of isophthalic acid and terephthalic acid wherein the weight ratio of isophthalic acid to terephthalic acid is 91:9 to 2:98. In another embodiment, D can be a C₂₋₆ alkylene group and T is p-phenylene, m-phenylene, naphthalene, a divalent cycloaliphatic group, or a combination thereof. This class of polyester includes the poly(alkylene terephthalates).

The molar ratio of ester units to carbonate units in the copolymers can vary broadly, for example 1:99 to 99:1, specifically 10:90 to 90:10, more specifically 25:75 to 75:25, depending on the desired properties of the final composition.

In a specific embodiment, the polyester unit of a polyester-polycarbonate can be derived from the reaction of a combination of isophthalic and terephthalic diacids (or derivatives thereof) with resorcinol. In another embodiment, the polyester unit of a polyester-polycarbonate can be derived from the reaction of a combination of isophthalic acid and terephthalic acid with bisphenol-A. In an embodiment, the polycarbonate units can be derived from bisphenol A. In another specific embodiment, the polycarbonate units can be derived from resorcinol and bisphenol A in a molar ratio of resorcinol carbonate units to bisphenol A carbonate units of 1:99 to 99:1.

Useful polyesters can include aromatic polyesters, poly(alkylene esters) including poly(alkylene arylates), and poly(cycloalkylene diesters). Aromatic polyesters can have a polyester structure according to formula (12), wherein D and T are each aromatic groups as described hereinabove. In an embodiment, useful aromatic polyesters can include, for example, poly(isophthalate-terephthalate-resorcinol) esters, poly(isophthalate-terephthalate-bisphenol-A) esters, poly[(isophthalate-terephthalate-resorcinol) ester-co-(isophthalate-terephthalate-bisphenol-A)]ester, or a combination comprising at least one of these.

(iii) Functional Characteristics of the First Polycarbonate

The first polycarbonate can have a variety of functional characteristics. They include at least one of the following characteristics articulated in section (iii), which are described below.

The first polycarbonate has a glass transition temperature (Tg) of greater than or equal to 170° C., 175° C., 180° C., 185° C., 190° C., 200° C., 210° C., 220° C., 230° C., 240° C., 250° C., 260° C., 270° C., 280° C., 290° C., or 300° C., as measured using a differential scanning calorimetry method.

The first polycarbonate can have a percent haze value of less than or equal to 10.0%, 8.0%, 6.0%, 5.0%, 4.0%, 3.0%, 2.0%, 1.0%, 1.5%, or 0.5% as measured at a thickness of 3.2 mm according to ASTM D 1003-07. The first polycarbonate can be measured at a 2.0, 2.2, 2.4, 2.6, 2.8, 3.0, 3.2, 3.4, 3.6, 3.8, or a 4.0 millimeter thickness. The first polycarbonate can be measured at a 0.125 inch (3.2 mm) thickness. The first polycarbonate can have a light transmittance greater than or equal to 70%, 75%, 80%, 85%, 90%, or 95%, as measured at 3.2 millimeters thickness according to ASTM D 1003-07. The first polycarbonate exhibits a heat resistance higher than the levels achieved with BPA homopolymer as described in the Examples.

b. Second Polycarbonate

Described herein is the second polycarbonate of the polycarbonate blend. The second polycarbonate is a different polycarbonate than the first polycarbonate. The second polycarbonate can be a homopolycarbonate or a copolycarbonate as is described above with respect to the first polycarbonate. For example, the second polycarbonate can be BPA polycarbonate, homopolymer, copolymer, or heteropolymer.

(i) Functional Characteristics of the Second Polycarbonate

The second polycarbonate can have a percent haze value of less than or equal to 10.0%, 8.0%, 6.0%, 5.0%, 4.0%, 3.0%, 2.0%, 1.0%, 1.5%, or 0.5% as measured at 3.2 millimeters thickness according to ASTM D 1003-07. The second polycarbonate can have a percent haze value of less than or equal to 3.0% as measured at 3.2 millimeters thickness according to ASTM D 1003-07.

### 3. METHOD OF MAKING FIRST AND SECOND POLYCARBONATES

Polycarbonates can be manufactured by processes such as interfacial polymerization and melt polymerization. High Tg copolycarbonates are generally manufactured using interfacial polymerization. Although the reaction conditions for interfacial polymerization can vary, an example of a process generally involves dissolving or dispersing a dihydric phenol reactant in aqueous caustic soda or potash, adding the resulting mixture to a water-immiscible solvent medium, and contacting the reactants with a carbonate precursor in the presence of a catalyst such as, for example, a tertiary amine or a phase transfer catalyst, under controlled pH conditions, e.g., 8 to 10. The most commonly used water immiscible solvents include methylene chloride, 1,2-dichloroethane, chlorobenzene, toluene, and the like.

Examples of carbonate precursors include, for example, a carbonyl halide such as carbonyl bromide or carbonyl chloride, or a haloformate such as a bishaloformates of a dihydric phenol (e.g., the bischloroformates of bisphenol A, hydroquinone, or the like) or a glycol (e.g., the bishaloformate of ethylene glycol, neopentyl glycol, polyethylene glycol, or the like). Combinations comprising at least one of the foregoing types of carbonate precursors can also be used. In an embodiment, an interfacial polymerization reaction to form carbonate linkages uses phosgene as a carbonate precursor, and is referred to as a phosgenation reaction.

Among tertiary amines that can be used are aliphatic tertiary amines such as triethylamine, tributylamine, cycloaliphatic amines such as N,N-diethyl-cyclohexylamine and aromatic tertiary amines such as N,N-dimethylaniline.

Among the phase transfer catalysts that can be used are catalysts of the formula (R³)₄Q⁺X, wherein each R³ is the same or different, and is a C₁₋₁₀ alkyl group; Q is a nitrogen or phosphorus atom; and X is a halogen atom or a C₁₋₈ alkoxy group or C₆₋₁₈ aryloxy group. Examples of phase transfer catalysts include, for example, [CH₃(CH₂)₃]₄NX, [CH₃(CH₂)₃]₄PX, [CH₃(CH₂)₅]₄NX, [CH₃(CH₂)₆]₄NX, [CH₃(CH₂)₄]₄NX, CH₃[CH₃(CH₂)₃]₃NX, and CH₃[CH₃(CH₂)₂]₃NX, wherein X is Cl⁻, Br⁻, a C₁₋₈ alkoxy group or a C₆₋₁₈ aryloxy group. An effective amount of a phase transfer catalyst can be 0.1 to 10 wt % based on the weight of bisphenol in the phosgenation mixture. In another embodiment an effective amount of phase transfer catalyst can be 0.5 to 2 wt % based on the weight of bisphenol in the phosgenation mixture.

The polycarbonate can be prepared by a melt polymerization process. Generally, in the melt polymerization process, polycarbonates are prepared by co-reacting, in a molten state, the dihydroxy reactant(s) (i.e. aliphatic diol and/or aliphatic diacid, and any additional dihydroxy compound) and a diaryl carbonate ester, such as diphenyl carbonate, or more specifically in an embodiment, an activated carbonate such as bis(methyl salicyl) carbonate, in the presence of a transesterification catalyst. The reaction can be carried out in typical polymerization equipment, such as one or more continuously stirred reactors (CSTR's), plug flow reactors, wire wetting fall polymerizers, free fall polymerizers, wiped film polymerizers, BANBURY* mixers, single or twin screw extruders, or combinations of the foregoing. Volatile monohydric phenol is removed from the molten reactants by distillation and the polymer is isolated as a molten residue. A specifically useful melt process for making polycarbonates uses a diaryl carbonate ester having electron-withdrawing substituents on the aryls. Examples of specifically useful diaryl carbonate esters with electron withdrawing substituents include bis(4-nitrophenyl)carbonate, bis(2-chlorophenyl)carbonate, bis(4-chlorophenyl)carbonate, bis(methyl salicyl)carbonate, bis(4-methylcarboxylphenyl)carbonate, bis(2-acetylphenyl)carboxylate, bis(4-acetylphenyl)carboxylate, or a combination comprising at least one of the foregoing

a. End Capping Agent

All types of polycarbonate end groups are contemplated as being useful in the high and low Tg polycarbonates, provided that such end groups do not significantly adversely affect desired properties of the compositions. An end-capping agent (also referred to as a chain-stopper) can be used to limit molecular weight growth rate, and so control molecular weight of the first and/or second polycarbonate. Examples of chain-stoppers include certain monophenolic compounds (i.e., phenyl compounds having a single free hydroxy group), monocarboxylic acid chlorides, and/or monochloroformates. Phenolic chain-stoppers are exemplified by phenol and C₁-C₂₂ alkyl-substituted phenols such as p-cumyl-phenol, resorcinol monobenzoate, and p- and tertiary-butyl phenol, cresol, and monoethers of diphenols, such as p-methoxyphenol. Alkyl-substituted phenols with branched chain alkyl substituents having 8 to 9 carbon atoms can be specifically mentioned.

Endgroups can derive from the carbonyl source (i.e., the diaryl carbonate), from selection of monomer ratios, incomplete polymerization, chain scission, and the like, as well as any added end-capping groups, and can include derivatizable functional groups such as hydroxy groups, carboxylic acid groups, or the like. In an embodiment, the endgroup of a polycarbonate can comprise a structural unit derived from a diaryl carbonate, where the structural unit can be an endgroup. In a further embodiment, the endgroup is derived from an activated carbonate. Such endgroups can derive from the transesterification reaction of the alkyl ester of an appropriately substituted activated carbonate, with a hydroxy group at the end of a polycarbonate polymer chain, under conditions in which the hydroxy group reacts with the ester carbonyl from the activated carbonate, instead of with the carbonate carbonyl of the activated carbonate. In this way, structural units derived from ester containing compounds or substructures derived from the activated carbonate and present in the melt polymerization reaction can form ester endgroups. In an embodiment, the ester endgroup derived from a salicylic ester can be a residue of BMSC or other substituted or unsubstituted bis(alkyl salicyl) carbonate such as bis(ethyl salicyl) carbonate, bis(propyl salicyl) carbonate, bis(phenyl salicyl) carbonate, bis(benzyl salicyl) carbonate, or the like. In a specific embodiment, where BMSC is used as the activated carbonyl source, the endgroup is derived from and is a residue of BMSC, and is an ester endgroup derived from a salicylic acid ester, having the structure of formula (13):

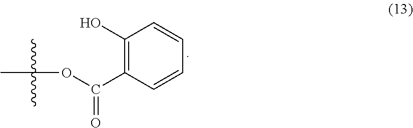 [SMILES: *OC(=O)c1ccccc1O]

The reactants for the polymerization reaction using an activated aromatic carbonate can be charged into a reactor either in the solid form or in the molten form. Initial charging of reactants into a reactor and subsequent mixing of these materials under reactive conditions for polymerization can be conducted in an inert gas atmosphere such as a nitrogen atmosphere. The charging of one or more reactant can also be done at a later stage of the polymerization reaction. Mixing of the reaction mixture is accomplished by any methods known in the art, such as by stirring. Reactive conditions include time, temperature, pressure and other factors that affect polymerization of the reactants. Typically the activated aromatic carbonate is added at a mole ratio of 0.8 to 1.3, specifically, 0.9 to 1.3, and all sub-ranges there between, relative to the total moles of monomer unit compounds. In a specific embodiment, the molar ratio of activated aromatic carbonate to monomer unit compounds is 1.013 to 1.29, specifically 1.015 to 1.028. In another specific embodiment, the activated aromatic carbonate is BMSC.

b. Branching Groups

Polycarbonates with branching groups are also contemplated as being useful, provided that such branching does not significantly adversely affect desired properties of the polycarbonate. Branched polycarbonate blocks can be prepared by adding a branching agent during polymerization. These branching agents include polyfunctional organic compounds containing at least three functional groups selected from hydroxyl, carboxyl, carboxylic anhydride, haloformyl, and mixtures of the foregoing functional groups. Specific examples include trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl)alpha, alpha-dimethyl benzyl)phenol), 4-chloroformyl phthalic anhydride, trimesic acid, and benzophenone tetracarboxylic acid. The branching agents can be added at a level of 0.05 to 2.0 wt %. Mixtures comprising linear polycarbonates and branched polycarbonates can be used.

### 4. OTHER ADDITIVES

a. UV Stabilizers

The polycarbonate blend can further comprise a UV stabilizer for improved performance in UV stabilization. UV stabilizers disperse the UV radiation energy.

UV stabilizers can be hydroxybenzophenones, hydroxyphenyl benzotriazoles, cyanoacrylates, oxanilides, and hydroxyphenyl triazines. UV stabilizers can include, but are not limited to, poly[(6-morphilino-s-triazine-2,4-diyl)[2,2,6,6-tetramethyl-4-piperidyl) imino]-hexamethylene[(2,2,6,6-tetramethyl-4-piperidyl)imino], 2-hydroxy-4-octloxybenzophenoe (Uvinul®3008), 6-tert-butyl-2-(5-chloro-2H-benzotriazole-2-yl)-4-methylphenyl (Uvinul® 3026), 2,4-di-tert-butyl-6-(5-chloro-2H-benzotriazole-2-yl)-phenol (Uvinul®3027), 2-(2H-benzotriazole-2-yl)-4,6-di-tert-pentylphenol (Uvinul®3028), 2-(2H-benzotriazole-2-yl)-4-(1,1,3,3-tetramethylbutyl)-phenol (Uvinul® 3029), 1,3-bis[(2′cyano-3′,3′-diphenylacryloyl)oxy]-2,2-bis-{[(2′-cyano-3′,3′-diphenylacryloyl)oxy]methyl}-propane (Uvinul® 3030), 2-(2H-benzotriazole-2-yl)-4-methylphenol (Uvinul® 3033), 2-(2H-bezhotriazole-2-yl)-4,6-bis(1-methyl-1-phenyethyl)phenol (Uvinul® 3034), ethyl-2-cyano-3,3-diphenylacrylate (Uvinul® 3035), (2-ethylhexyl)-2-cyano-3,3-diphenylacrylate (Uvinul® 3039), N,N′-bisformyl-N,N′-bis(2,2,6,6-tetramethyl-4-piperidinyl)hexamethylendiamine (Uvinul® 4050H), bis-(2,2,6,6-tetramethyl-4-pipieridyl)-sebacate (Uvinul® 4077H), bis-(1,2,2,6,6-pentamethyl-4-piperdiyl)-sebacate+methyl-(1,2,2,6,6-pentamethyl-4-piperidyl)-sebacate (Uvinul® 4092H) or a combination thereof.

The polycarbonate blend can comprise one or more UV stabilizers, including Cyasorb 5411, Cyasorb UV-3638, Uvinul 3030, and/or Tinuvin 234.

Certain monophenolic UV absorbers, which can also be used as capping agents, can be utilized as one or more additives; for example, 4-substituted-2-hydroxybenzophenones and their derivatives, aryl salicylates, monoesters of diphenols such as resorcinol monobenzoate, 2-(2-hydroxyaryl)-benzotriazoles and their derivatives, 2-(2-hydroxyaryl)-1,3,5-triazines and their derivatives, and the like.

b. Colorants

Colorants such as pigment and/or dye additives can be present in the composition. Useful pigments can include, for example, inorganic pigments such as metal oxides and mixed metal oxides such as zinc oxide, titanium dioxides, iron oxides, or the like; sulfides such as zinc sulfides, or the like; aluminates; sodium sulfo-silicates sulfates, chromates, or the like; carbon blacks; zinc ferrites; ultramarine blue; organic pigments such as azos, di-azos, quinacridones, perylenes, naphthalene tetracarboxylic acids, flavanthrones, isoindolinones, tetrachloroisoindolinones, anthraquinones, enthrones, dioxazines, phthalocyanines, and azo lakes; Pigment Red 101, Pigment Red 122, Pigment Red 149, Pigment Red 177, Pigment Red 179, Pigment Red 202, Pigment Violet 29, Pigment Blue 15, Pigment Blue 60, Pigment Green 7, Pigment Yellow 119, Pigment Yellow 147, Pigment Yellow 150, and Pigment Brown 24; or combinations comprising at least one of the foregoing pigments. Pigments are generally used in amounts of 0.01 to 10 parts by weight, based on 100 parts by weight of the polymer component of the thermoplastic composition.

Examples of dyes are generally organic materials and include, for example, coumarin dyes such as coumarin 460 (blue), coumarin 6 (green), nile red or the like; lanthanide complexes; hydrocarbon and substituted hydrocarbon dyes; polycyclic aromatic hydrocarbon dyes; scintillation dyes such as oxazole or oxadiazole dyes; aryl- or heteroaryl-substituted poly (C₂₋₈) olefin dyes; carbocyanine dyes; indanthrone dyes; phthalocyanine dyes; oxazine dyes; carbostyryl dyes; napthalenetetracarboxylic acid dyes; porphyrin dyes; bis(styryl)biphenyl dyes; acridine dyes; anthraquinone dyes; cyanine dyes; methine dyes; arylmethane dyes; azo dyes; indigoid dyes, thioindigoid dyes, diazonium dyes; nitro dyes; quinone imine dyes; aminoketone dyes; tetrazolium dyes; thiazole dyes; perylene dyes, perinone dyes; bis-benzoxazolylthiophene (BBOT); triarylmethane dyes; xanthene dyes; thioxanthene dyes; naphthalimide dyes; lactone dyes; fluorophores such as anti-stokes shift dyes which absorb in the near infrared wavelength and emit in the visible wavelength, or the like; luminescent dyes such as 7-amino-4-methylcoumarin; 3-(2′-benzothiazolyl)-7-diethylaminocoumarin; 2-(4-biphenylyl)-5-(4-t-butylphenyl)-1,3,4-oxadiazole; 2,5-bis-(4-biphenylyl)-oxazole; 2,2′-dimethyl-p-quaterphenyl; 2,2-dimethyl-p-terphenyl; 3,5,3″″,5″″-tetra-t-butyl-p-quinquephenyl; 2,5-diphenylfuran; 2,5-diphenyloxazole; 4,4′-diphenylstilbene; 4-dicyanomethylene-2-methyl-6-(p-dimethylaminostyryl)-4H-pyran; 1,1′-diethyl-2,2′-carbocyanine iodide; 3,3′-diethyl-4,4′,5,5′-dibenzothiatricarbocyanine iodide; 7-dimethylamino-1-methyl-4-methoxy-8-azaquinolone-2; 7-dimethylamino-4-methylquinolone-2; 2-(4-(4-dimethylaminophenyl)-1,3-butadienyl)-3-ethylbenzothiazolium perchlorate; 3-diethylamino-7-diethyliminophenoxazonium perchlorate; 2-(1-naphthyl)-5-phenyloxazole; 2,2′-p-phenylen-bis(5-phenyloxazole); rhodamine 700; rhodamine 800; pyrene, chrysene, rubrene, coronene, or the like; or combinations comprising at least one of the foregoing dyes. Dyes are generally used in amounts of 0.01 to 10 parts by weight, based on 100 parts by weight of the polycarbonate component of the blend.

c. Flame Retardants

Various types of flame retardants can also be utilized as additives. In one embodiment, the flame retardant additives include, for example, flame retardant salts such as alkali metal salts of perfluorinated C₁₋₁₆ alkyl sulfonates such as potassium perfluorobutane sulfonate (Rimar salt), potassium perfluoroctane sulfonate, tetraethylammonium perfluorohexane sulfonate, potassium diphenylsulfone sulfonate (KSS), and the like, sodium benzene sulfonate, sodium toluene sulfonate (NATS) and the like; and salts formed by reacting for example an alkali metal or alkaline earth metal (for example lithium, sodium, potassium, magnesium, calcium and barium salts) and an inorganic acid complex salt, for example, an oxo-anion, such as alkali metal and alkaline-earth metal salts of carbonic acid, such as Na₂CO₃, K₂CO₃, MgCO₃, CaCO₃, and BaCO₃ or fluoro-anion complex such as Li₃AlF₆, BaSiF₆, KBF₄, K₃AlF₆, KAlF₄, K₂SiF₆, and/or Na₃AlF₆ or the like. Rimar salt and KSS and NATS, alone or in combination with other flame retardants, are particularly useful in the polycarbonate compositions disclosed herein.

In another embodiment, the flame-retardants are selected from at least one of the following: alkali metal salts of perfluorinated C₁₋₁₆ alkyl sulfonates; potassium perfluorobutane sulfonate; potassium perfluoroctane sulfonate; tetraethylammonium perfluorohexane sulfonate; and potassium diphenylsulfone sulfonate.

In another embodiment, the flame retardant is not a bromine, or chlorine, or iodine, or phosphorus containing composition.

In another embodiment, the flame retardant additives include organic compounds that include phosphorus, bromine, and/or chlorine. Non-brominated and non-chlorinated phosphorus-containing flame retardants can be used in certain applications for regulatory reasons, for example organic phosphates and organic compounds containing phosphorus-nitrogen bonds. One type of organic phosphate is an aromatic phosphate of the formula (GO)₃P═O, wherein each G is independently an alkyl, cycloalkyl, aryl, alkylaryl, or arylalkyl group, provided that at least one G is an aromatic group. Two of the G groups can be joined together to provide a cyclic group, for example, diphenyl pentaerythritol diphosphate. Exemplary aromatic phosphates include, phenyl bis(dodecyl) phosphate, phenyl bis(neopentyl) phosphate, phenyl bis(3,5,5′-trimethylhexyl) phosphate, ethyl diphenyl phosphate, 2-ethylhexyl di(p-tolyl) phosphate, bis(2-ethylhexyl) p-tolyl phosphate, tritolyl phosphate, bis(2-ethylhexyl) phenyl phosphate, tri(nonylphenyl) phosphate, bis(dodecyl) p-tolyl phosphate, dibutyl phenyl phosphate, 2-chloroethyl diphenyl phosphate, p-tolyl bis(2,5,5′-trimethylhexyl) phosphate, 2-ethylhexyl diphenyl phosphate, or the like. A specific aromatic phosphate is one in which each G is aromatic, for example, triphenyl phosphate, tricresyl phosphate, isopropylated triphenyl phosphate, and the like.

Di- or poly-functional aromatic phosphorus-containing compounds are also useful as additives, for example, compounds of the formulas below:

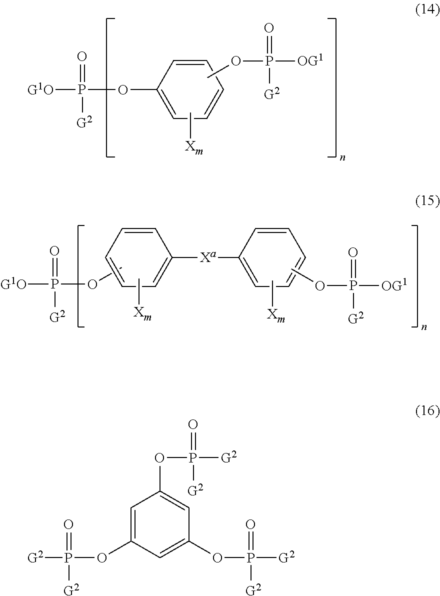

wherein each G¹ is independently a hydrocarbon having 1 to 30 carbon atoms; each G² is independently a hydrocarbon or hydrocarbonoxy having 1 to 30 carbon atoms; each X is independently a bromine or chlorine; m is 0 to 4, and n is 1 to 30. Examples of di- or polyfunctional aromatic phosphorus-containing compounds include resorcinol tetraphenyl diphosphate (RDP), the bis(diphenyl) phosphate of hydroquinone and the bis(diphenyl) phosphate of bisphenol-A, respectively, their oligomeric and polymeric counterparts, and the like.

Examples of flame retardant additives containing phosphorus-nitrogen bonds include phosphonitrilic chloride, phosphorus ester amides, phosphoric acid amides, phosphonic acid amides, phosphinic acid amides, tris(aziridinyl) phosphine oxide.

The flame retardant additive can be halogen containing compositions have formula (26):

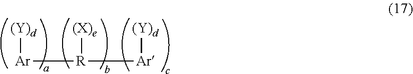

wherein R is a C₁₋₃₆ alkylene, alkylidene or cycloaliphatic linkage, e.g., methylene, ethylene, propylene, isopropylene, isopropylidene, butylene, isobutylene, amylene, cyclohexylene, cyclopentylidene, or the like; or an oxygen ether, carbonyl, amine, or a sulfur-containing linkage, e.g., sulfide, sulfoxide, sulfone, or the like. R can also consist of two or more alkylene or alkylidene linkages connected by such groups as aromatic, amino, ether, carbonyl, sulfide, sulfoxide, sulfone, or the like.

Ar and Ar′ in formula (17) are each independently mono- or polycarbocyclic aromatic groups such as phenylene, biphenylene, terphenylene, naphthylene, or the like.

Y is an organic, inorganic, or organometallic radical, for example (1) halogen, e.g., chlorine, bromine, iodine, fluorine or (2) ether groups of the general formula OB, wherein B is a monovalent hydrocarbon group similar to X or (3) monovalent hydrocarbon groups of the type represented by R or (4) other substituents, e.g., nitro, cyano, and the like, said substituents being essentially inert provided that there is greater than or equal to one, specifically greater than or equal to two, halogen atoms per aryl nucleus. One or both of Ar and Ar′ can further have one or more hydroxyl substituents.

When present, each X is independently a monovalent hydrocarbon group, for example an alkyl group such as methyl, ethyl, propyl, isopropyl, butyl, decyl, or the like; an aryl groups such as phenyl, naphthyl, biphenyl, xylyl, tolyl, or the like; and aralkyl group such as benzyl, ethylphenyl, or the like; a cycloaliphatic group such as cyclopentyl, cyclohexyl, or the like. The monovalent hydrocarbon group can itself contain inert substituents.

Each d is independently 1 to a maximum equivalent to the number of replaceable hydrogens substituted on the aromatic rings comprising Ar or Ar′. Each e is independently 0 to a maximum equivalent to the number of replaceable hydrogens on R. Each a, b, and c is independently a whole number, including 0. When b is not 0, neither a nor c can be 0. Otherwise either a or c, but not both, can be 0. Where b is 0, the aromatic groups are joined by a direct carbon-carbon bond.

The hydroxyl and Y substituents on the aromatic groups, Ar and Ar′ can be varied in the ortho, meta or para positions on the aromatic rings and the groups can be in any possible geometric relationship with respect to one another.

Included within the scope of polymeric or oligomeric flame retardants derived from mono or dihydroxy derivatives of formula (17) are: 2,2′,6,6′-tetrabromo-4,4′-isopropylidenediphenol [also known as 2,2-bis(3,5-dibromo-4-hydroxyphenyl)propane], 2,2-bis-(3,5-dichlorophenyl)-propane; bis-(2-chlorophenyl)-methane; bis(2,6-dibromophenyl)-methane; 1,1-bis-(4-iodophenyl)-ethane; 1,2-bis-(2,6-dichlorophenyl)-ethane; 1,1-bis-(2-chloro-4-iodophenyl)ethane; 1,1-bis-(2-chloro-4-methylphenyl)-ethane; 1,1-bis-(3,5-dichlorophenyl)-ethane; 2,2-bis-(3-phenyl-4-bromophenyl)-ethane; 2,6-bis-(4,6-dichloronaphthyl)-propane; 2,2-bis-(2,6-dichlorophenyl)-pentane; 2,2-bis-(3,5-dibromophenyl)-hexane; bis-(4-chlorophenyl)-phenyl-methane; bis-(3,5-dichlorophenyl)-cyclohexylmethane; bis-(3-nitro-4-bromophenyl)-methane; bis-(4-hydroxy-2,6-dichloro-3-methoxyphenyl)-methane; and 2,2-bis-(3,5-dichloro-4-hydroxyphenyl)-propane 2,2 bis-(3-bromo-4-hydroxyphenyl)-propane. Also included within the above structural formula are: 1,3-dichlorobenzene, 1,4-dibromobenzene, 1,3-dichloro-4-hydroxybenzene, and biphenyls such as 2,2′-dichlorobiphenyl, polybrominated 1,4-diphenoxybenzene, 2,4′-dibromobiphenyl, and 2,4′-dichlorobiphenyl as well as decabromo diphenyl oxide, and the like.

Another useful class of flame retardant is the class of siloxanes (e.g., cyclic siloxanes and/or linear siloxanes) having the general formula (R₂SiO)y wherein R is a monovalent hydrocarbon or fluorinated hydrocarbon having from 1 to 18 carbon atoms and y is a number from 3 to 12. Examples of fluorinated hydrocarbon include, but are not limited to, 3-fluoropropyl, 3,3,3-trifluoropropyl, 5,5,5,4,4,3,3-heptafluoropentyl, fluorophenyl, difluorophenyl and trifluorotolyl. Examples of suitable cyclic siloxanes include, but are not limited to, octamethylcyclotetrasiloxane, 1,2,3,4-tetramethyl-1,2,3,4-tetravinylcyclotetrasiloxane, 1,2,3,4-tetramethyl-1,2,3,4-tetraphenylcyclotetrasiloxane, octaethylcyclotetrasiloxane, octapropylcyclotetrasiloxane, octabutylcyclotetrasiloxane, decamethylcyclopentasiloxane, dodecamethylcyclohexasiloxane, tetradecamethylcycloheptasiloxane, hexadecamethylcyclooctasiloxane, eicosamethylcyclodecasiloxane, octaphenylcyclotetrasiloxane, and the like. A particularly useful cyclic siloxane is octaphenylcyclotetrasiloxane.

Another useful class of compounds that can be combined with flame retardant additives or used in combination with cyclic siloxanes with flame retardant additives are poly(phenylalkylsiloxanes) where the alkyl group is a C₁-C₁₈ alkyl group. On specific example of a polyalkylphenylsiloxane is a poly(phenylmethylsiloxane)

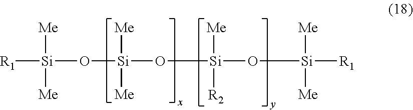

where R₁ is methyl and R₂ is phenyl and x and y can vary in ratio but sum to 1. The presence of phenyl groups in the linear siloxane structure in general improves transparency and reduces haze in the polycarbonate formulation. One such poly(phenylmethylsiloxane) is available commercially from Toshiba Silicone Co. LTD. as TSF437. TSF437 is a liquid at room temperature (viscosity 22 centistokes at 25° C.) and so is particularly convenient to add to polymer compositions.

Combining phenyl-containing cyclic siloxanes such as octaphenylcyclotetrasiloxane with phenyl containing linear siloxanes such as TSF437 with flame retardant additives such as Rimar salt has been found to be particularly effective in providing excellent flame performance and high impact performance while maintaining excellent transmittance and low haze in polycarbonate compositions.

In one embodiment, the flame retardant contains a sulfonate or derivatives thereof.

In another embodiment, the sulfonate is an alkaline and/or alkaline earth sulfonate.

In another embodiment, the flame retardant is at least one of the following: potassium fluorosulfonate or derivatives thereof; KSS, NATS (sodium p-tolylsulfonate), and ionomer.

In another embodiment, the flame retardant does not contain a bromine and/or chlorine containing molecules.

When present, the foregoing flame retardant additives are generally present in amounts of 0.01 wt % to 2.0 wt %, specifically 0.02 wt % to 1.0 wt %, and more specifically, 0.7 wt % to 0.9 wt %, and yet more specifically 0.8 wt %, based on 100 parts by weight of the polymer component of the thermoplastic composition. For example, potassium perfluorobutane sulfonate (Rimar salt) and/or siloxane (specifically octaphenylcyclotetrasiloxane. A flame retardant, can comprise a Rimar salt, linear phenyl containing siloxane(s), and cyclic phenyl containing siloxane(s).

In addition to the flame retardant, for example, the herein described polycarbonates and blends can include various additives ordinarily incorporated in polycarbonate compositions, with the proviso that the additives are selected so as to not significantly adversely affect the desired properties of the polycarbonate, such as transparency. Combinations of additives can be used. Such additives can be mixed at a suitable time during the mixing of the components for forming the polycarbonate and/or blend.

d. Heat Stabilizers

Examples of heat stabilizer additives include, for example, organophosphites such as triphenyl phosphite, tris-(2,6-dimethylphenyl)phosphite, tris-(mixed mono- and di-nonylphenyl)phosphite or the like; phosphonates such as dimethylbenzene phosphonate or the like, phosphates such as trimethyl phosphate, or the like, or combinations comprising at least one of the foregoing heat stabilizers. Heat stabilizers are generally used in amounts of 0.0001 to 1 part by weight, based on 100 parts by weight of the polymer component of the thermoplastic composition.

f. Mold Release Agents/Anti-Oxidants/Anti-drip Agents

Various mold release agents, anti-oxidants, and anti-drip agents can be utilized and one of ordinary skill in the art would be able to select said chemistries without undue experimentation.

In one embodiment, the mold release agent is PETs release agent.

In another embodiment, the anti-oxidant is a hindered phenol anti-oxidant.

In another embodiment, the anti-drip agent can an encapsulated polytetrafluroethylene or fibril containing chemistry.

### 5. MIXERS AND EXTRUDERS

The polycarbonate blend can be manufactured by various methods. For example, the first and second polycarbonates can be first blended in a high speed HENSCHEL-Mixer®. Other low shear processes, including but not limited to hand mixing, can also accomplish this blending. The blend can then be fed into the throat of a single or twin-screw extruder via a hopper. Alternatively, at least one of the components can be incorporated into the composition by feeding directly into the extruder at the throat and/or downstream through a sidestuffer. Additives can also be compounded into a masterbatch with a desired polymeric resin and fed into the extruder. The extruder is generally operated at a temperature higher than that necessary to cause the composition to flow. The extrudate is immediately quenched in a water batch and pelletized. The pellets, so prepared, when cutting the extrudate can be one-fourth inch long or less as desired. Such pellets can be used for subsequent molding, shaping, or forming.

### 6. ARTICLES

Shaped, formed, or molded articles comprising the polycarbonate blends are provided herein. The compositions can be molded into a flame housing having any desirable shape to retain a combustible fuel and a medium for a flame (e.g., a wick). Some examples of fuels include wax (e.g., liquid wax, and/or non-liquid wax), oil, and combinations comprising at least one of the foregoing. The flame housing can be a candle container. The container can have any desired shape and size, e.g., based upon aesthetics instead of upon thermal requirements. Since the polycarbonate blend has sufficient heat tolerance sufficient to avoid warpage and melting at candle temperatures (e.g., Tg), and sufficient fire resistance performance to avoid burning when in close contact with a candle flame (V0 at 3.0 and 2.5 mm) as well as passing the specific flame test for candle holders, ASTM F 2417-09, section 5.4) the size and shape and thickness are not restricted as when other plastics are used, such as a standard polycarbonate having a Tg of less than or equal to 150° C.

In a particular embodiment, the polycarbonate composition (e.g., the polycarbonate blend) can be used to replace aluminum or glass in candleholder articles, e.g., that are tea light cups or votive light cups, with a volume of less than or equal to 8 ounces (oz.) (236.6 cubic centimeters (cc)), specifically, 1 oz (29.6 cc) to 8 oz (236.6 cc). The candles can be scented or unscented in these articles. Replacement of glass eliminates breakage issues for the candle industry while replacing aluminum improves the aesthetics of the candleholder for the consumer.

### 7. EXAMPLES OF EMBODIMENTS

In one embodiment, a flame element can comprise: a flame housing, a fuel located in the flame housing, and a medium for a flame located in the housing and in contact with the fuel. The flame housing can be formed from a polycarbonate blend comprising: a first polycarbonate having a limited oxygen index of greater than or equal to 25% and a glass transition temperature of greater than 170° C. as measured using a differential scanning calorimetry method, wherein the first polycarbonate is derived from a monomer having the structure HO-A₁-Y₁-A₂-OH wherein each of A₁ and A₂ comprise a monocyclic divalent arylene group, and Y₁ is a bridging group having an atom, and wherein the structure is free of halogen atoms; and a second polycarbonate having a Tg of less than or equal to 170° C. and wherein the second polycarbonate is different than the first polycarbonate. The blend has a Tg of greater than or equal to 170° C. as measured using a differential scanning calorimetry method. A 3.2 mm plaque molded from the polycarbonate blend has a YI of less than or equal to 10; a 3.2 mm plaque molded from the polycarbonate blend has a transmission of greater than 80% as measured using a method of ASTM D1003-07; and a 3.0 mm plaque of the polycarbonate blend possesses a greater than or equal to a UL94 V0 rating.

In another embodiment, a flame element can comprise: a flame housing, a fuel located in the flame housing, and a medium for a flame located in the housing and in contact with the fuel. The flame housing is formed from a polycarbonate blend comprising: a first polycarbonate having a Tg of greater than 170° C. as measured using a differential scanning calorimetry method, wherein the first polycarbonate comprises carbonate units derived from at least one of the following monomers 3,3-bis(4-hydroxyphenyl)-2-phenylisoindolin-1-one (PPPBP), 1,1-bis(4-hydroxyphenyl)-1-phenyl-ethane (Bisphenol-AP), and 1,1-bis(4-hydroxyphenyl)-3,3,5-trimethyl-cyclohexane (Bisphenol-TMC), and a dihydroxy compound derived from fluorene and/or adamantane structures; and a second polycarbonate different than the first polycarbonate. A molded article of the polycarbonate blend has a transmission of greater than or equal to 70% as measured using the method of ASTM D1003-07 at 0.125 inches (3.2 mm) in part thickness. The polycarbonate blend possesses a Tg greater than or equal to 170° C., and a 3.0 mm plaque of the polycarbonate blend possesses a greater than or equal to a UL94 V0 rating.

In yet another embodiment, a flame element can comprise a flame housing formed from a polycarbonate blend, a fuel located in the flame housing, and a medium for a flame located in the housing and in contact with the fuel. The polycarbonate blend comprises a polycarbonate, and a 2-phenyl-3,3-bis(4-hydroxyphenyl)phthalimidine/BPA polycarbonate copolymer in an amount greater than 50 wt % of a total weight of the blend. The polycarbonate blend is free of a flame retardant phosphorous containing compound, and has at least a UL94 V0 fire rating at a plaque thickness of 3 mm. The polycarbonate and the 2-phenyl-3,3-bis(4-hydroxyphenyl)phthalimidine/BPA polycarbonate copolymer are different, and wherein the 2-phenyl-3,3-bis(4-hydroxyphenyl)phthalimidine/BPA polycarbonate copolymer has a yellowness index of less than 10 as measured on a 3.2 mm thick plaque in accordance with ASTM D1925.

In still another embodiment, a flame element can comprise a flame housing a fuel located in the flame housing, and a medium for a flame located in the housing and in contact with the fuel. The flame housing can be formed from a polycarbonate blend comprising: a first polycarbonate having a Tg of greater than 170° C. as measured using a differential scanning calorimetry method, wherein the first polycarbonate comprises a polyester polycarbonate copolymer; and a second polycarbonate different than the first polycarbonate. A molded article of the polycarbonate blend has a transmission of greater than or equal to 70% as measured using the method of ASTM D 1003-07 at or 3.2 mm in part thickness. The polycarbonate blend possesses a Tg greater than or equal to 170° C., and a 3.0 mm plaque of the polycarbonate blend possesses a greater than or equal to a UL94 V0 rating.

In still a further embodiment, a flame element can comprise a flame housing, a fuel located in the flame housing, and a medium for a flame located in the housing and in contact with the fuel. The flame housing is formed from a polycarbonate composition, comprising: 50 wt % to 100 wt % of a first polycarbonate having a Tg of greater than 170° C. as measured using a differential scanning calorimetry method, wherein the first polycarbonate comprises carbonate units derived from at least one of the following monomers 3,3-bis(4-hydroxyphenyl)-2-phenylisoindolin-1-one (PPPBP), 1,1-bis(4-hydroxyphenyl)-1-phenyl-ethane (Bisphenol-AP), and 1,1-bis(4-hydroxyphenyl)-3,3,5-trimethyl-cyclohexane (Bisphenol-TMC), and a dihydroxy compound derived from fluorene and adamantane structures; and up to 50 wt % of a second polycarbonate different than the first polycarbonate; wherein the weight percent is based on the sum of the first polycarbonate and the second polycarbonate being equal to 100 wt %. A molded article of the polycarbonate blend has a transmission of greater than or equal to 70% as measured using the method of ASTM D1003-07 at 0.125 inches (3.2 mm) in part thickness. The polycarbonate blend possesses a Tg greater than or equal to 170° C., and a 3.0 mm plaque of the polycarbonate blend possesses a greater than or equal to a UL94 V0 rating.

In the various embodiments, (i) the flame element is a candle; and/or (ii) the medium for a flame is a wick; and/or (iii) the fuel is wax; and/or (iv) the first polycarbonate comprises 3,3-bis(4-hydroxyphenyl)-2-phenylisoindolin-1-one (PPPBP); and/or (v) the first polycarbonate comprises 1,1-bis(4-hydroxyphenyl)-1-phenyl-ethane (Bisphenol-AP); and/or (vi) the first polycarbonate comprises 1,1-bis(4-hydroxyphenyl)-3,3,5-trimethyl-cyclohexane (Bisphenol-TMC); and/or (vii) the first polycarbonate further comprises carbonate units derived from 2,2-bis(4-hydroxyphenyl)propane (Bisphenol-A); and/or (viii) the first polycarbonate comprises greater than or equal to 12 mol % of carbonate units derived from at least one of the following 3,3-bis(4-hydroxyphenyl)-2-phenylisoindolin-1-one (PPPBP), 1,1-bis(4-hydroxyphenyl)-1-phenyl-ethane(Bisphenol-AP), and 1,1-bis(4-hydroxyphenyl)-3,3,5-trimethyl-cyclohexane (Bisphenol-TMC); and/or (ix) the second polycarbonate comprises less than 50 wt % of the polycarbonate blend and wherein the first polycarbonate comprises greater than or equal to 50 wt % of the polycarbonate blend based on the sum of the first and second polycarbonates being equal to 100 wt %; and/or (x) the first polycarbonate comprises 4,4′-(3,3,5-trimethylcyclohexane-1,1-diyl)diphenol; and/or (xi) the fuel is at least one of the following oil and wax; and/or (x) the flame element is a candle; and/or (xii) comprising 10 wt % to 20 wt % of the first polycarbonate and 80 wt % to 90 wt % of the second polycarbonate, based on the sum of the first and the second polycarbonate being equal to 100 wt %; and/or (xiii) further comprising 0.01 wt % to 1.0 wt % flame retardant additive, based on 100 parts by weight of the polymer component of the thermoplastic composition; and/or (xiv) further comprising 0.7 wt % to 0.9 wt % flame retardant additive, based on 100 weight percent of the blend; and/or (xv) the flame retardant is at least one of the following potassium perfluorobutane sulfonate and siloxane; and/or (xvi) the flame retardant comprises potassium perfluorobutane sulfonate and octaphenylcyclotetrasiloxane; and/or (xvii) the flame retardant comprises potassium perfluorobutane sulfonate, linear phenyl containing siloxane, and cyclic phenyl containing siloxane; and/or (xviii) the transmission is greater than or equal to 80% at 3.2 mm, the UL94 rating of V0 is at a thickness of 2.5 mm; and/or (xix) the second polycarbonate is bisphenol-A polycarbonate; and/or (xx) the polymer blend has at least a UL94 V0 fire rating at a plaque thickness of 2.5 mm; and/or (xxi) the flame retardant phosphorus containing compound is at least one of the following triphenylphosphate, tricresylphosphate, resorcinol bis(diphenylphosphate), tris(nonyl)phenylphosphate, and BPA diphosphate; and/or (xxii) the first polycarbonate can comprise an adamantyl and/or a fluorene units; and/or (xxiii) a dihydroxy compound derived from fluorene and/or adamantane units; and/or (xiv) the first polycarbonate comprises an aromatic dihydroxy compound (optionally, the aromatic dihydroxy compound can be the same or different).

### Examples

In the examples, phenolphthalein phenyl phthalimide bisphenol polycarbonate (PPPBP PC) is PC copolymer with 25 mole percent (mol %) or 48 mol % PPPBP segments the remainder of the formulation being BPA to add up to 100 mol %. The heat stabilizer utilized was IRGAFOS* 168 (tris(2,4-di-t-butylphenyl) phosphite) and hindered phenol anti-oxidant. The mold release agent was pentaethyritol tetrastearate. The polycarbonates utilized in the blends have the following characteristics: high flow Bisphenol-A polycarbonate prepared by the interfacial method with a target molecular weight of 21,900 (based on Gel Permeation chromatography measurements using polycarbonate standards), and medium flow Bisphenol-A polycarbonate prepared by the interfacial method with a target molecular weight of 29,900 (based on Gel Permeation chromatography measurements using polycarbonate standards).

As shown in Table 1, a polycarbonate composition without PPPBP PC (batch 1 in Table 1), passes V0@ 3.0 mm, but fails at thinner wall thicknesses. Those compositions containing PPPBP PC (25 mol % or 48 mol % PPPBP, batch 2-7) show improved FR performance. Higher PPPBP-content in the PC-resin results in better FR-performance (See batch 2, 4 and 6). In addition, different FR additives (Rimar Salt in batches 2-4 and KSS, potassium diphenylsulfone sulfonate, in batch 5) can achieve similar FR-ratings (batch 4 and 5). At the same time, HDT also increases as the amount of PPPBP in the formulations increases (batch 1 vs. batch 2, 4 or 6). Furthermore, FR additives and high wt % PPPBP content are needed in order to achieve thin wall V0 FR performance at very thin wall thickness such as 1.6 mm (batch 6 versus batch 7). These results demonstrate that when PPPBP is introduced into polycarbonate higher HDT values and better FR performance results compared with BPA PC. Higher HDT values and better FR performance could be particularly useful for thin wall articles such as candle holders that require both excellent FR performance at thin wall thicknesses and heat stability (resistance to warpage at elevated temperatures). It is noted that the throughout the Tables when examples include PPPBP copolymers, the amount of PPPBP in the copolymer is described in mol % and the remainder is BPA to add up to 100 mol %. For example in Batch 2 in Table 1 the formulation of the copolymer is 25 mol % PPPBP and 75 mol % BPA. It is further noted that throughout the examples, the weights of the polymer components total 100 parts per hundred (pph). All the other additives such as Rimar Salt are added to the 100 pph of the polymer composition. For example the polymer composition in Batch 2 of Table 1 is composed of 60 pph of a polycarbonate having 25 mol % PPPBP monomer and 75 mol % BPA and 40 pph of a BPA polycarbonate for a total of 100 pph. To determine the weight % of the Rimar Salt in the composition of Batch 2 divide 0.04 Rimar Salt by the total weight of the composition and multiply by 100% (wt % Rimar Salt=0.04/100.04×100%).

TABLE 1

| Batch No. | 1 | 2 | 3 | 4 | 5 | 6 | 7 |
|---|---|---|---|---|---|---|---|
| 48 mol % | | | | | | 100 | 100 |
| PPPBP PC | | | | | | | |
| 25 mol % | | 60 | 60 | 100 | 100 | | |
| PPPBP PC | | | | | | | |
| Medium | 35 | 40 | 40 | | | | |
| Flow PC | | | | | | | |
| High Flow | 65 | | | | | | |
| PC | | | | | | | |
| Rimar Salt | 0.08 | 0.04 | 0.08 | 0.08 | | 0.08 | |
| KSS | | | | | 0.3 | | |
| Trans- | T | T | T | T | T | T | T |
| parent/ | | | | | | | |
| Opaque* | | | | | | | |
| Content | 0 | 15 | 15 | 25 | 25 | 48 | 48 |
| of PPPBP | | | | | | | |
| (%) | | | | | | | |
| HDT@ | 126 | 151 | 151 | 162 | 162 | 193 | 193 |
| 1.82 Pa, | | | | | | | |
| 3.2 mm | | | | | | | |
| V0@3.0 | Pass | Pass | Pass | Pass | Pass | Pass | Pass |
| mm | | | | | | | |
| V0@2.3 | Fail | Pass | Pass | Pass | Pass | Pass | |
| mm | | | | | | | |
| V0@2.0 | Fail | Fail | Fail | Pass | Pass | Pass | |
| mm | | | | | | | |
| V0@1.6 | Fail | Fail | Fail | Fail | Fail | Pass | Fail |
| mm | | | | | | | |

*In order to be identified as transparent, a 3.2 mm plaque of the composition has a transparency of greater than or equal to 80%

As shown in Table 2, a surprising result was seen with blend the composition prepared from 48% PPPBP PC in combination BPA PC. The transparency and haze characteristics are improved by adding Rimar salt. In the absence of Rimar salt the blend is opaque (Exp2-1) while the addition of rimar salt substantially improves the transmission and haze and the blend is transparent (Exp 2-2). Table 3 also illustrates that increasing the amount of PPPBP PC in the blended formulations improves the FR performance at thin wall thicknesses (Exp 2-2 having 29 wt % PPPBP is V0 @ 2.0 mm, while Exp 2-4 having 14 wt % PPPBP content in the blend formulation fails the UL test for V0 rating at 2.0 mm).

TABLE 2

| | Exp 2-1 | Exp 2-2 | Exp 2-3 | Exp 2-4 |
|---|---|---|---|---|
| 48% PPPBP PC | 60 | 60 | 45 | 30 |
| 100 grade PC | 40 | 40 | 55 | 70 |
| Rimar | | 0.08 | 0.08 | 0.08 |
| Content of PPPBP (wt %) | 29 | 29 | 22 | 14 |
| Transmission/3.2 mm | 49.6 | 89.2 | 89.1 | 90.3 |
| Haze/3.2 mm | 53.4 | 1 | 1.16 | 2 |
| HDT @ 1.82 Pa | 161 | 161 | 149 | 140 |
| V0 @ 3.0 mm | Fail | Pass | Pass | Pass |
| V0 @ 2.5 mm | Fail | Pass | Pass | Pass |
| V0 @ 2.0 mm | Fail | Pass | Pass | Fail |

As shown in Table 3 combinations of KSS (potassium diphenylsulfone sulfonate) and NaTS (sodium toluene sulfonate) salts are also useful as flame retardant additives and surprisingly perform better in combination than either one alone for blends with the same level of PPPBP content. For example a blend formulation with KSS alone (Exp 3-1) fails the V0 test at 2.5 mm as does a blend formulation with NaTS alone but the combination of the two salts (Exp 3-4) passes the a 2.5 mm.

TABLE 3

| | Exp3-1 | Exp3-2 | Exp3-3 | Exp3-4 | Exp3-5 | Exp3-6 |
|---|---|---|---|---|---|---|
| 48% PPPBP | 60 | 60 | 100 | 60 | 45 | 30 |
| PC | | | | | | |
| 100 grade PC | 40 | 40 | | 40 | 55 | 70 |
| KSS | 0.09 | | 0.07 | 0.07 | 0.07 | 0.07 |
| NaTS | | 0.09 | 0.02 | 0.02 | 0.02 | 0.02 |
| Content of | 29 | 29 | 48 | 29 | 22 | 14 |
| PPPBP (wt %) | | | | | | |
| Transmission/ | 89.3 | 84 | 85.4 | 89.3 | 90.2 | 90.3 |
| 3.2 mm | | | | | | |
| Haze/3.2 mm | 1 | 27.2 | 1.5 | 1 | 1.1 | 1.2 |
| HDT@1.82 Pa | 161 | 161 | 193 | 161 | 148 | 139 |
| V0@3.0 mm | Pass | Pass | Pass | Pass | Pass | Pass |
| V0@2.5 mm | Fail | Fail | Pass | Pass | Pass | Pass |

TABLE 4

| | Exp 4-1 | Exp 4-2 | Exp 4-3 | Exp 4-4 |
|---|---|---|---|---|
| 33% PPPBP PC | 80 | 64 | 45 | 24 |
| 100 grade PC | 20 | 17 | 18 | 21 |
| PC1700 | | 19 | 37 | 55 |
| Rimar | 0.08 | 0.08 | 0.08 | 0.08 |
| Content of PPPBP (wt %) | 26 | 22 | 15 | 8 |
| Transmission/3.2 mm | 88.6 | 89.4 | 90.2 | 90.8 |
| Haze/3.2 mm | 1 | 0.8 | 0.7 | 0.3 |
| HDT @ 1.82 Pa, 3.2 mm | 161 | 151 | 140 | 132 |
| V0 @ 3.0 mm(Normal, Aging) | Pass | Pass | Pass | Pass |
| V0 @ 2.5 mm(Normal, Aging) | Pass | Pass | Pass | Pass |
| V0 @ 2.0 mm(Normal, Aging) | Pass | Pass | Fail | Fail |

The results from Table 4 show results from blend formulations based on a 33 mol % PPPBP/BPA copolymer. Examples, Exp 4-1 and Exp 4-2 provide the high HDT (greater than 150 @ 1.82 megaPascals (mPa), 3.2 mm) and high transmission (greater than 85%) and low haze (less than 2%) needed for the candle application as well as excellent FR performance at thin wall thicknesses (V0 rating at 2.0 mm).

The experimental results described above compare different blend formulations with different amounts of PPPBP content and different types of FR additives. The data provide guidance in the selection of blend formulations for candle holder applications that require higher HDT performance than BPA polycarbonate while still requiring the high transparency and low haze characteristics of BPA polycarbonate, and comparable or better V0 FR performance at thin wall thicknesses. Based on the experimental results and balancing the flow requirements of the candle holder application, with the high transparency and low haze needs and the higher HDT and comparable or better FR requirements blend formulations could be selected and one of these is illustrated in Table 5.

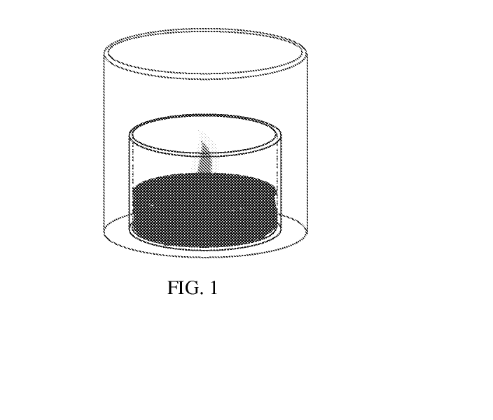

Tea light cups were tested in the configuration of FIG. 1 (with the tea light cup located inside of a metal container which caused the heat to rise). Sample A comprised a LEXAN* 920a polycarbonate cup with wax and a wick in the cup. LEXAN* 920a polycarbonate has an LOI of 27%, and a Tg of 150° C., has a % T of 85% at a molded plaque thickness of 2.54 mm, and UL94 V0 rating at a molded plaque thickness of 3 mm. Sample B comprised a high heat polycarbonate cup (with the formulation shown in Table 5) with the same type of wax and wick in the cup. Although both samples passed ASTM F2417-09 section 5.4, Sample A warped while Sample B was intact.

TABLE 5
(with Tg of 185° C.)

| Tg | Material | *PPH |
|---|---|---|
| 195° C. | 33 mol % PPPBP/BPA copolycarbonate | 82 |
| | **Mw = 23,000 | |
| 150° C. | Median flow homopolymer BPA | 9 |
| | polycarbonate with PCP end cap | |
| | Mw = 30,000 | |
| 145° C. | High flow BPA polycarbonate with PCP end | 9 |
| | cap; Mw = 22,500 | |
| | PHOSPHITE STABILIZER | 0.08 |
| | PETS mold release agent | 0.3 |
| | HINDERED PHENOL ANTI-OXIDANT | 0.04 |
| | Rimar salt; POTASSIUM | 0.08 |
| | PERFLUOROBUTANE SULFONATE | |
| | (Global Master) | |
| | UV stabilizer Tinuin 234 | 0.27 |
| | OCTAPHENYLCYCLOTETRASILOXANE | 0.1 |

*PPH is parts per hundred based upon 100 parts by weight of the polymer
**“Mw” is weight-average molecular weight as measured by Gel Permeation Chromatography using polycarbonate molecular weight standards.

The blend formulation described in Table 5 has a glass transition temperature of 185° C. Molded parts from the formulation of Table 5 show a notched izod impact of 86.7 joules per meter (J/m) as measured using the method of ASTM D256, and HDT values of 174° C. at 0.45 megapascals (MPa) and 165° C. at 1.82 MPa as measured using the method of ASTM D648 and a UL rating of V0 at 2.5 mm as determined using the UL test protocol. Other properties of the formulation are listed in Table 6 below.

TABLE 6

| Parameter Code | Description | Min | Target | Max |
|---|---|---|---|---|
| % Transmission @ | Light Transmission @ 3.2 | 80 | | |
| 3.2 mm | mm; ASTM D1003 | | | |
| MFR | Tested at 330° C., 2.16 kg | 20 | 25 | 30 |
| % Haze @ 3.2 mm | ASTM E313-73 (D1925) | | | 3% |

A set of experiments was performed using different formulations of phenolphthalein phenyl phthalimide bisphenol polycarbonate (PPPBP PC) with combinations of BPA PC (low flow PC), and FR package Potassium perfluorobutane sulfonate (Rimar), or potassium diphenylsulfone sulfonate (KSS).

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A flame element, comprising:
a flame housing, wherein the flame housing is formed from a polycarbonate blend comprising:
(a) a first polycarbonate having a limited oxygen index of greater than or equal to 25% and a glass transition temperature of greater than 170° C. as measured using a differential scanning calorimetry method, wherein the first polycarbonate is derived from a monomer having the structure HO-A₁-Y₁-A₂-OH wherein each of A₁ and A₂ comprise a monocyclic divalent arylene group, and Y₁ is a bridging group having an atom, and wherein the structure is free of halogen atoms;
(b) a second polycarbonate having a Tg of less than or equal to 170° C. and wherein the second polycarbonate is different than the first polycarbonate;
wherein the blend has a Tg of greater than or equal to 170° C. as measured using a differential scanning calorimetry method;
wherein a 3.2 mm plaque molded from the polycarbonate blend has a YI of less than or equal to 10;
wherein a 3.2 mm plaque molded from the polycarbonate blend has a transmission of greater than 80% as measured using a method of ASTM D1003-07; and
wherein a 3.0 mm plaque of the polycarbonate blend possesses a greater than or equal to a UL94 V0 rating; and
a fuel located in the flame housing; and
a medium for a flame located in the housing and in contact with the fuel.

2. A flame element, comprising:
a flame housing, wherein the flame housing is formed from a polycarbonate blend comprising:
(a) a first polycarbonate having a Tg of greater than 170° C. as measured using a differential scanning calorimetry method, wherein the first polycarbonate comprises carbonate units derived from at least one of the following monomers 3,3-bis(4-hydroxyphenyl)-2-phenylisoindolin-1-one (PPPBP), 1,1-bis(4-hydroxyphenyl)-1-phenyl-ethane (Bisphenol-AP), and 1,1-bis(4-hydroxyphenyl)-3,3,5-trimethyl-cyclohexane (Bisphenol-TMC), and a dihydroxy compound derived from fluorene and adamantane structures; and
(b) a second polycarbonate different than the first polycarbonate;
wherein, a molded article of the polycarbonate blend has a transmission of greater than or equal to 70% as measured using the method of ASTM D1003-07 at 3.2 mm in part thickness;
wherein the polycarbonate blend possesses a Tg greater than or equal to 170° C., and a 3.0 mm plaque of the polycarbonate blend possesses a greater than or equal to a UL94 V0 rating; and
a fuel located in the flame housing; and
a medium for a flame located in the housing and in contact with the fuel.

3. A flame element, comprising:
a flame housing, wherein the flame housing is formed from a polycarbonate blend comprising:
(a) a first polycarbonate having a Tg of greater than 170° C. as measured using a differential scanning calorimetry method, wherein the first polycarbonate comprises a polyester polycarbonate copolymer; and
(b) a second polycarbonate different than the first polycarbonate;
wherein, a molded article of the polycarbonate blend has a transmission of greater than or equal to 70% as measured using the method of ASTM D 1003-07 at or 3.2 mm in part thickness;
wherein the polycarbonate blend possesses a Tg greater than or equal to 170° C., and a 3.0 mm plaque of the polycarbonate blend possesses a greater than or equal to a UL94 V0 rating; and
a fuel located in the flame housing; and
a medium for a flame located in the housing and in contact with the fuel.

4. A flame element, comprising:
a flame housing, wherein the flame housing is formed from a polycarbonate composition, comprising:
(a) 50 wt % to 100 wt % of a first polycarbonate having a Tg of greater than 170° C. as measured using a differential scanning calorimetry method, wherein the first polycarbonate comprises carbonate units derived from at least one of the following monomers 3,3-bis(4-hydroxyphenyl)-2-phenylisoindolin-1-one (PPPBP), 1,1-bis(4-hydroxyphenyl)-1-phenyl-ethane (Bisphenol-AP), and 1,1-bis(4-hydroxyphenyl)-3,3,5-trimethyl-cyclohexane (Bisphenol-TMC), and a dihydroxy compound derived from fluorene and adamantane structures; and
(b) up to 50 wt % of a second polycarbonate different than the first polycarbonate;
wherein the weight percent is based on the sum of the first polycarbonate and the second polycarbonate being equal to 100 wt %;
wherein, a molded article of the polycarbonate blend has a transmission of greater than or equal to 70% as measured using the method of ASTM D1003-07 at 3.2 mm in part thickness;
wherein the polycarbonate blend possesses a Tg greater than or equal to 170° C., and a 3.0 mm plaque of the polycarbonate blend possesses a greater than or equal to a UL94 V0 rating; and
a fuel located in the flame housing; and
a medium for a flame located in the housing and in contact with the fuel.

5. The flame element of claim 4, wherein the first polycarbonate comprises greater than or equal to 12 mol % of carbonate units derived from at least one of the following 3,3-bis(4-hydroxyphenyl)-2-phenylisoindolin-1-one (PPPBP), 1,1-bis(4-hydroxyphenyl)-1-phenyl-ethane(Bisphenol-AP), and 1,1-bis(4-hydroxyphenyl)-3,3,5-trimethyl-cyclohexane (Bisphenol-TMC).

6. The flame element of claim 1, wherein the first polycarbonate comprises 3,3-bis(4-hydroxyphenyl)-2-phenylisoindolin-1-one (PPPBP).

7. The flame element of any of claim 1, wherein the first polycarbonate comprises 1,1-bis(4-hydroxyphenyl)-1-phenyl-ethane (Bisphenol-AP).

8. The flame element of claim 1, wherein the first polycarbonate comprises 1,1-bis(4-hydroxyphenyl)-3,3,5-trimethyl-cyclohexane (Bisphenol-TMC).

9. The flame element of claim 1, wherein the first polycarbonate further comprises carbonate units derived from 2,2-bis(4-hydroxyphenyl)propane (Bisphenol-A).

10. The flame element of claim 1, wherein the first polycarbonate comprises adamantyl and fluorene units.

11. The flame element of claim 1, wherein the first polycarbonate comprises an aromatic dihydroxy compound derived from adamantyl and/or fluorene units.

12. The flame element of claim 5, wherein the first polycarbonate further comprises carbonate units derived from 2,2-bis(4-hydroxyphenyl)propane (Bisphenol-A).

13. The flame element of claim 4, wherein the second polycarbonate comprises less than 50 wt % of the polycarbonate blend and wherein the first polycarbonate comprises greater than or equal to 50 wt % of the polycarbonate blend based on the sum of the first and second polycarbonates being equal to 100 wt %.

14. The flame element of claim 4, wherein the polycarbonate blend comprises 10 wt % to 20 wt % of the first polycarbonate and 80 wt % to 90 wt % of the second polycarbonate, based on the sum of the first and the second polycarbonate being equal to 100 wt %.

15. The flame element of claim 4, wherein the first polycarbonate comprises 4,4′-(3,3,5-trimethylcyclohexane-1,1-diyl)diphenol.

16. A flame element, comprising:
a flame housing formed from a polycarbonate blend comprising
a polycarbonate, and
a 2-phenyl-3,3-bis(4-hydroxyphenyl)phthalimidine/BPA polycarbonate copolymer in an amount greater than 50 wt % of a total weight of the blend,
wherein the polycarbonate blend is free of a flame retardant phosphorous containing compound, and has at least a UL94 V0 fire rating at a plaque thickness of 3 mm,
wherein the polycarbonate and the 2-phenyl-3,3-bis(4-hydroxyphenyl)phthalimidine/BPA polycarbonate copolymer are different, and wherein the 2-phenyl-3,3-bis(4-hydroxyphenyl)phthalimidine/BPA polycarbonate copolymer has a yellowness index of less than 10 as measured on a 3.2 mm thick plaque in accordance with ASTM D1925;
a fuel located in the flame housing; and
a medium for a flame located in the housing and in contact with the fuel.

17. The flame element of claim 4, wherein the fuel is at least one of the following: oil and wax.

18. The flame element of claim 1, wherein the flame element is a candle.

19. The flame element of claim 4, wherein the UL94 rating of V0 is at a thickness of 2.5 mm.

20. The flame element of claim 19, wherein the transmission is greater than or equal to 80% at 3.2 mm.

21. The flame element of claim 20, wherein the second polycarbonate is bisphenol-A polycarbonate.

22. The flame element of claim 19, wherein the polycarbonate blend further comprises 0.01 wt % to 1.0 wt % flame retardant additive, based on 100 parts by weight of the polymer component of the thermoplastic composition.

23. The flame element of claim 22, wherein the polycarbonate blend comprises 0.7 wt % to 0.9 wt % flame retardant additive, based on 100 parts by weight of the polymer component of the thermoplastic composition.

24. The flame element of claim 22, wherein the flame retardant phosphorus containing compound is at least one of the following: triphenylphosphate, tricresylphosphate, resorcinol bis(diphenylphosphate), tris(nonyl)phenylphosphate, and BPA diphosphate.

25. The flame element of claim 22, wherein the flame retardant is at least one of the following: potassium perfluorobutane sulfonate and siloxane.

26. The flame element of claim 25, wherein the flame retardant comprises potassium perfluorobutane sulfonate and octaphenylcyclotetrasiloxane.

27. The flame element of claim 22, wherein the flame retardant comprises potassium perfluorobutane sulfonate, linear phenyl containing siloxane, and cyclic phenyl containing siloxane.
